(19) United States
(12) Patent Application Publication
(10) Pub. No.: US 2019/0337250 A1
(43) Pub. Date: Nov. 7, 2019

(54) SELF-SEALING PNEUMATIC VEHICLE TYRE AND METHOD FOR THE PRODUCTION THEREOF

(71) Applicant: Continental Reifen Deutschland GmbH, Hannover (DE)

(72) Inventors: Markus Dahlke, Wunstorf (DE); Joe Guardalabene, Hannover (DE); Fabian Schax, Seelze (DE); Andreas Tyburski, Ilsede (DE)

(73) Assignee: Continental Reifen Deutschland GmbH, Hannover (DE)

(21) Appl. No.: 16/306,982

(22) PCT Filed: Mar. 30, 2017
(86) PCT No.: PCT/EP2017/057483

§ 371 Date: Dec. 4, 2018

(30) Foreign Application Priority Data
Jun. 22, 2016 (DE) 10 2016 211 111.6

(51) Int. Cl. B29D 30/06; B29C 73/22; B29C 73/16; B60C 19/12

(52) U.S. Cl. CPC B29D 30/0685; B29C 73/22; B29C 73/166; B29D 2030/0697; B60C 19/122; B29D 2030/0695; B29C 73/163

(57) ABSTRACT

The invention relates to a self-sealing pneumatic vehicle tire having a belt package (2), a tread (1) arranged radially above the belt package (2) and an airtight inner layer (4) arranged radially on the inside, wherein the self-sealing of the pneumatic vehicle tire is obtained via a sealant layer (5) subsequently applied radially on the inside after the vulcanization of the pneumatic vehicle tire, wherein the sealant layer (5) has essentially the width of the belt package (2) and is arranged essentially in the projection thereof and has a cross section which is formed in a cross-sectional plane including the tire axis and has a surface (5a) running essentially parallel to the belt package in axial direction and a surface (5b) running essentially in radial direction.

It is a feature of the invention that at least the surface of the sealant layer (5a) running essentially parallel to the belt package in axial direction has a circumferential coating (6) that contains at least elastomer particles.

In the method of the invention, the sealant layer is coated at least with elastomer particles.

The invention relates to a self-sealing pneumatic vehicle tire having a belt package, a tread arranged radially above the belt package and an airtight inner layer arranged radially on the inside, wherein the self-sealing of the pneumatic vehicle tire is obtained via a sealant layer subsequently applied radially on the inside after the vulcanization of the pneumatic vehicle tire, wherein the sealant layer has essentially the width of the belt package and is arranged essentially in the projection thereof and has a cross section which is formed in a cross-sectional plane including the tire axis and has a surface running essentially parallel to the belt package in axial direction and a surface running essentially in radial direction. The invention also relates to a method of producing a self-sealing pneumatic vehicle tire of this kind.

Pneumatic vehicle tires of this kind with self-sealing configuration are known, for example, from the applicant's DE 10 2006 059 286 A1. These involve subsequently providing standard tire constructions with a sealant layer. The sealant is a self-adhesive, viscous sealing compound which is applied as a layer from the inside in radial direction in the projection region of the belt package to the radially innermost tire layer, the largely airtight inner layer. The sealant layer is capable of automatically sealing punctures of up to 5 millimeters in diameter. After a puncture through the tread to through the inner layer, the sealant completely surrounds the penetrating foreign body, seals the interior off from the environment and hence prevents loss of compressed air from the tire. The driver of the vehicle is not forced to replace the defective tire immediately with an equivalent replacement wheel or an emergency wheel.

The sealant is used by the applicant under the ContiSeal® name. The sealant is notable for airtightness, high tackiness and balanced flow characteristics.

Owing to the high tackiness of the sealant in the sealant layer, unwanted foreign bodies that get into the interior of the tire (for example during the storage of the tire) stick to the sealant layer, in this context particularly to the surface of the sealant layer directed radially inward. The surface directed radially outward sticks to the inner layer and is therefore not exposed.

US 2014/0174639 A1 discloses lowering the tackiness by coating the sealant layer with cotton fibers or aramid fibers or glass fibers or lamellar fillers such as graphites, mica or talc. However, particles of this kind can adversely affect the sealing effect in the event of a puncture, since they can adversely affect the occlusion of the puncture site.

It is an object of the present invention to provide a self-sealing pneumatic vehicle tire and a method of production thereof, in which no foreign bodies (or only a very small degree thereof) adhere to the sealant layer within the tire, with no impairment of the sealing performance of the sealant.

The object is achieved in accordance with the invention in that at least the surface of the sealant layer running essentially parallel to the belt package in axial direction has a circumferential coating that contains at least elastomer particles.

In the method of the invention, the sealant layer is coated at least with elastomer particles.

A coating of this kind with elastomer particles lowers the tackiness of the surface of the sealant layer directed radially inward to such a significant degree that (virtually) no unwanted foreign bodies stick to the sealant layer.

Elastomer particles as coating additionally do not impair the occlusion of the puncture site. The pneumatic vehicle tire of the invention thus additionally does not have any impairment with regard to the self-sealing properties.

In a preferred embodiment of the invention, the elastomer particles have a particle size of 0.05 to 2 mm. The elastomer particles may thus be powder or granules. The shape of the elastomer particles may be spherical, two-dimensional or elongated. Over and above a particle size of >1 mm, the particles are granules.

Powder in the context of the present invention is also referred to as flour.

A preferred embodiment of the invention involves elastomer particles that are in powder form and preferably have a particle size of 0.05 to 1 mm, more preferably 0.1 to 1 mm. In the context of the present invention, the term “particle size” is understood to mean the numerical average of the particle size distribution. The particle size or particle size distribution is determined in the context of the present invention according to DIN 53734 via the sieve residue from air-jet sieving.

In the context of the present invention, the term “elastomer particles” is understood to mean vulcanized, i.e. crosslinked, or at least partly vulcanized or unvulcanized or devulcanized or at least partly devulcanized particles of elastomers or elastomer mixtures. Vulcanized elastomer particles may, for example and with preference, according to the particle size, be rubber flour or rubber powder or rubber granules which can be obtained by grinding vulcanized industrial rubber articles including motor vehicle tires or the tire components, or by buffing vehicle tires, preferably used tires. Used tires are understood to mean vehicle tires that are available for recycling after use.

Partly vulcanized elastomer particles may, for example and with preference, be particles of a pre-crosslinked rubber mixture from the production of rubber mixtures, preferably for pneumatic vehicle tires. These too may be in the form of flour/powder or granules.

Unvulcanized elastomer particles may, for example and with preference, be particles of an uncrosslinked rubber mixture from the production of rubber mixtures, preferably for pneumatic vehicle tires.

Devulcanized elastomer particles may, for example and with preference, be particles of a devulcanized rubber mixture from used tires, also known as regenerated rubber material. Methods of devulcanizing vulcanized, especially sulfur-crosslinked, rubber mixtures are known to those skilled in the art. In this case, the preferably sulfur-crosslinked rubber vulcanizate is first comminuted. The sulfur-crosslinked rubber vulcanizate is comminuted by means of grinding methods known in the prior art, especially an ambient or cryogenic grinding method. The comminuted rubber vulcanizate is then devulcanized by, in the case of sulfur crosslinking, breaking all the sulfur bridges possible without damaging the polymer chains. A suitable method is described, for example, in WO 2014032818 A1. Partly devulcanized elastomer particles are correspondingly incompletely devulcanized particles.

Preferably, the elastomer particles are based on natural polyisoprene and/or synthetic polyisoprene and/or polybutadiene and/or styrene-butadiene copolymer and/or butyl rubber and/or halobutyl rubber and/or nitrile-butadiene rubber (NBR) and/or hydrogenated acrylonitrile butadiene rubber (HNBR) and/or ethylene-propylene-diene rubber (EPDM), each in the corresponding form, i.e. in unvulcanized, at least partly vulcanized, vulcanized, devulcanized or at least partly devulcanized form.

In a particularly advantageous embodiment of the invention, the elastomer particles are at least one regenerated rubber material, including the preferred and particularly preferred embodiments described.

In the case of sulfur-vulcanized rubber vulcanizates, these may preferably be based on the following rubbers alone or in blended form: natural polyisoprene (NR) and/or synthetic polyisoprene (IR) and/or butadiene rubber (BR) and/or styrene-butadiene rubber (SBR) and/or butyl rubber and/or halobutyl rubber and/or nitrile-butadiene rubber (NBR) and/or hydrogenated acrylonitrile-butadiene rubber (HNBR) and/or ethylene-propylene-diene rubber (EPDM). Here too, the rubbers mentioned are then in the corresponding form in each case, i.e. in unvulcanized, at least partly vulcanized, vulcanized, devulcanized or at least partly devulcanized form, and in the form of flour/powder or granules.

More preferably, the sulfur-crosslinked rubber vulcanizate comprises natural polyisoprene (NR) and/or synthetic polyisoprene (IR) and/or butadiene rubber (BR) and/or styrene-butadiene rubber (SBR) and/or butyl rubber and/or halobutyl rubber.

A mixture of various elastomer particles among those mentioned is also conceivable.

The present invention further provides a method of producing a self-sealing pneumatic vehicle tire, and all the embodiments described, especially those relating to the coating and the application, are applicable both to the pneumatic vehicle tire of the invention and to the method of the invention.

The elastomer particles are preferably applied to the inner surfaces of the tire that are to be coated with a spray gun having suitable nozzle diameter, preferably with rotation of the tire. This distributes the elastomer particles uniformly on the sealant layer.

Suitable spray guns, especially for applying preferably aqueous suspensions of the abovementioned type, are known to those skilled in the art. Spray guns are also referred to as spray pistols.

The spray gun used preferably has a nozzle having an opening with a diameter of 0.1 to 6 mm.

The spraying is preferably effected in a program-controlled manner, with controlled guiding of the spray pistol and exclusion of regions of the tire in which the coating is not to be applied, for example the bead region. Thus, the coating is preferably not applied where the pneumatic vehicle tire of the invention rests on the wheel rim or is in contact with the wheel rim, in order to avoid slippage between the tire and wheel rim in the contact area.

Application with a spray gun is thus comparatively simple and can be effected in an automated manner.

In a preferred development of the invention, the coating additionally contains at least one alkali metal salt of at least one fatty acid and/or at least one alkaline earth metal salt of at least one fatty acid. Preferably, the coating in this case is applied in the form of an aqueous suspension comprising the elastomer particles, in which case at least a majority of the water present in the suspension evaporates, leaving a coating containing, as well as the elastomer particles, at least one alkali metal salt of at least one fatty acid and/or at least one alkaline earth metal salt of at least one fatty acid.

In this case, according to the method, not the entire amount of the water is evaporated and a residual amount can thus remain in the coating.

In a preferred embodiment of the invention, the coating therefore contains water.

In a further preferred embodiment, the coating contains only very small amounts of water or no water at all, i.e. 0% to 1% by weight of water.

When the coating contains one or more salts of fatty acids, the tackiness of the surface of the sealant layer is lowered further. At the same time, the sealing performance of the self-sealing pneumatic vehicle tire having such a coating is not adversely affected.

Fatty acids are known to the person skilled in the art and, according to Römpp Online® 2015, are “aliphatic, saturated and unsaturated carboxylic acids with an unbranched carbon chain, but for a few exceptions”.

It is particularly preferable in the context of the present invention when the fatty acid has 8 to 18 carbon atoms.

This particularly effectively prevents the above-described reaction of amines with peroxides to give unwanted crystals. The number of 8 to 18 carbon atoms is particularly preferred when the chains are linear unbranched carbon chains.

Preferred fatty acids, or salts thereof as described below, are, for example and especially octanoic acid (also called caprylic acid) having 8 carbon atoms and/or tetradecanoic acid (also called myristic acid) having 14 carbon atoms and/or hexadecanoic acid (also called palmitic acid) having 16 carbon atoms and/or octadecanoic acid (also called stearic acid) having 18 carbon atoms.

In a preferred embodiment of the invention, the fatty acid is selected from the group consisting of octanoic acid and/or tetradecanoic acid and/or hexadecanoic acid and/or octadecanoic acid.

In a particularly preferred embodiment of the invention, the fatty acid is at least octadecanoic acid.

According to the invention, the at least one fatty acid is present in the coating in the form of at least one alkali metal and/or alkaline earth metal salt.

In the context of the present invention, “alkali metal salt of at least one fatty acid” is understood to mean the alkali metal salt of at least one fatty acid, where alkali metals in salts have a formal single positive charge, for example and especially the alkali metal ions of lithium (Li⁺), sodium (Na⁺), potassium (K⁺), rubidium (Rb⁺).

Preferably, the alkali metal ion of the salt is lithium (Li⁺) and/or sodium (Na⁺) and/or potassium (K⁺).

The ions of the fatty acid have a formal single negative charge, such that, in the alkali metal salt of the fatty acid, one alkali metal ion and one ion of the fatty acid (carboxylate ion) in each case correspond to a formal neutral charge.

The at least one alkali metal salt of at least one fatty acid may also be a mixture of different alkali metal salts in which the alkali metals and/or the fatty acids are the same or different than one another. The same applies to the at least one alkaline earth metal salt of at least one fatty acid. This too may be a mixture in which the alkaline earth metals and/or fatty acids are the same or different than one another.

In the context of the present invention, “alkaline earth metal salt of at least one fatty acid” is understood to mean the alkaline earth metal salt of at least one fatty acid, where alkaline earth metals in salts have a formal double positive charge, for example and especially the alkaline earth metal ions beryllium (Be⁺²), magnesium (Mg²⁺), calcium (Ca²⁺), etc. Preferably, the alkaline earth metal ion of the salt is magnesium (Mg²⁺) and/or calcium (Ca²⁺), more preferably calcium (Ca²⁺).

In the alkaline earth metal salt of the fatty acid, one alkaline earth metal ion and two ions of the fatty acid correspond to a formal neutral charge.

In a preferred embodiment of the invention, the coating contains at least one alkali metal salt of at least one fatty acid and at least one alkaline earth metal salt of at least one fatty acid.

In a particularly preferred embodiment of the invention, the alkaline earth metal salt of at least one fatty acid is at least calcium stearate.

A suitable aqueous suspension containing calcium stearate and at least one alkali metal salt of at least one fatty acid is available, for example, under the Rhenodiv® BO 7672-1 trade name from Rheinchemie.

A suspension of this kind, prior to the application and drying, contains 58% to 70% by weight of water, 10% to 20% by weight of at least one alkali metal salt of at least one fatty acid, 10% to 20% by weight of calcium stearate and less than 2% by weight of additives or impurities.

In this case, the weight ratio of elastomer particles to the aqueous suspension in the application is preferably 1:10 to 1:1.

Assuming that all water has evaporated out of the suspension, the weight ratio of the elastomer particles to the solid residue (composed of alkali metal salt of at least one fatty acid and calcium stearate) in the dried tire is thus preferably 1:4.2 to 1:0.3.

This particularly effectively avoids impairment of the sealing effect in the event of a puncture.

When the elastomer particles are applied in a suspension as described, they are preferably applied by means of a spray gun or a rotating spray turntable. In this case, the apparatus, especially the nozzle of a spray gun, may need to be adapted. In the case of application with a rotating spray turntable, the tire may likewise be rotated, but in that case it is preferably not rotated.

Spray turntables are known to those skilled in the art. In this case, the liquid to be sprayed (or suspension, optionally with adjustment of the speed of rotation of the spray turntable) is applied via a conduit to the turntable, which spins the liquid/suspension onto the interior of the tire via centripetal forces owing to the rotation. Here too, the spraying is preferably effected in a controlled manner with exclusion of the regions that are not to be coated, for example the bead region.

In the context of the present invention, the expression “essentially” in the description of the arrangement of the individual components of the pneumatic vehicle tire of the invention means that customary slight production-related variations are included.

The sealant layer has essentially the width of the belt package.

The sealant layer is arranged essentially in the projection thereof (the projection of the belt package), meaning that it runs radially within the belt package essentially parallel thereto. The sealant layer has a cross section which is formed in the cross-sectional plane including the tire axis and has a surface running essentially parallel to the belt package in axial direction and a surface running essentially in radial direction.

The sealant layer preferably has essentially a rectangular cross section, and may have curvature according to the configuration of the tire dimensions, especially in projection of the shoulder edges of the belt package.

The sealant layer is bounded by the inner layer in the radially outward direction and by its surface directed radially inward that runs in axial direction, essentially parallel to the belt package, in the radially inward direction, and is bounded on either side, preferably essentially symmetrically, by the surfaces that run in radial direction, essentially at right angles to the belt package.

In order to effectively lower the tackiness of the sealant layer (on the surface directed radially inward and hence exposed to the inside), the coating is applied at least to the surface of the sealant layer directed radially inward, which runs essentially parallel to the belt package, in a circumferential manner.

Since the surface of the sealant layer directed radially inward and hence exposed in the inward direction is typically rough and the elastomer particles do not have a flat surface, the resulting thickness of the coating is determined predominantly by the particle size of the elastomer particles.

If the elastomer particles are present in the preferably aqueous suspension described, the resulting thickness of the coating is likewise predominantly determined by the particle size of the elastomer particles.

In a preferred development of the invention, in addition, at least the surface of the coating that runs in the radial direction, essentially at right angles to the belt package, has the coating as described above, including all embodiments, comprising at least one alkali metal salt of at least one fatty acid and/or at least one alkaline earth metal salt of at least one fatty acid. This means both lateral surfaces of the sealant layer running in radial direction (to the left and right in the cross section explained above).

More preferably, the coating additionally contains, as well as elastomer particles, at least one alkali metal salt of at least one fatty acid and/or at least one alkaline earth metal salt of at least one fatty acid.

In this way, the entire exposed surface of the sealant layer is coated and the lowering of the tackiness is thus particularly effective over the entire region of the sealant layer, i.e. in the lateral regions of the sealant layer as well.

By virtue of the production method, the coating can be applied to the surfaces of the sealant layer exposed in the inward direction in such a way that there is an overlap with the inner layer on either side in axial direction. In the case of application in the aqueous suspension described, this overlap would be apparent in the form of a gray haze on the corresponding regions of the inner layer.

The axial width of the overlap on each side is preferably 0.5 to 10 mm, preferably 0.5 to 2 mm, more preferably 0.5 to 1 mm.

If the elastomer particles are applied in dry form, i.e. without suspension, however, according to the elastomer, these do not adhere for long on the inner layer, and so no permanent overlap with the inner layer can be assumed.

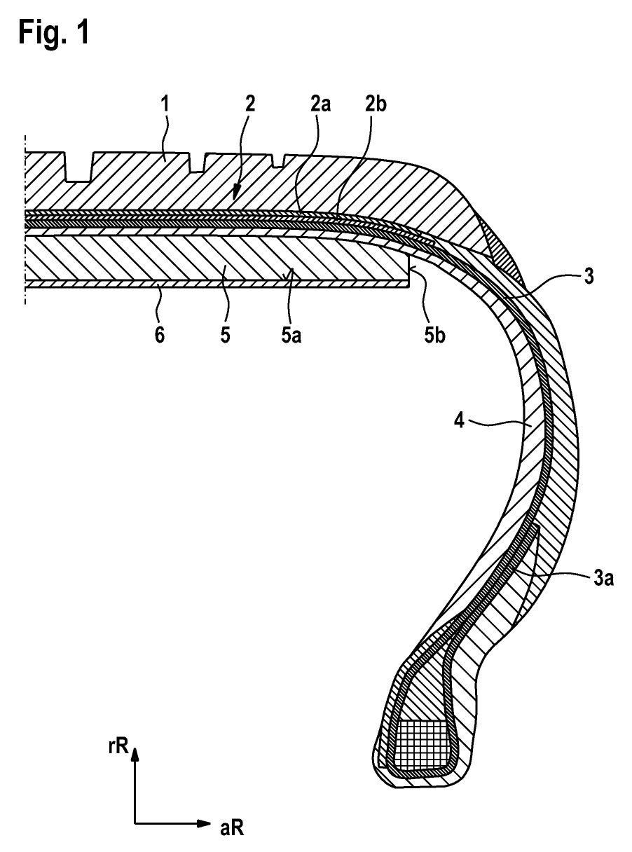

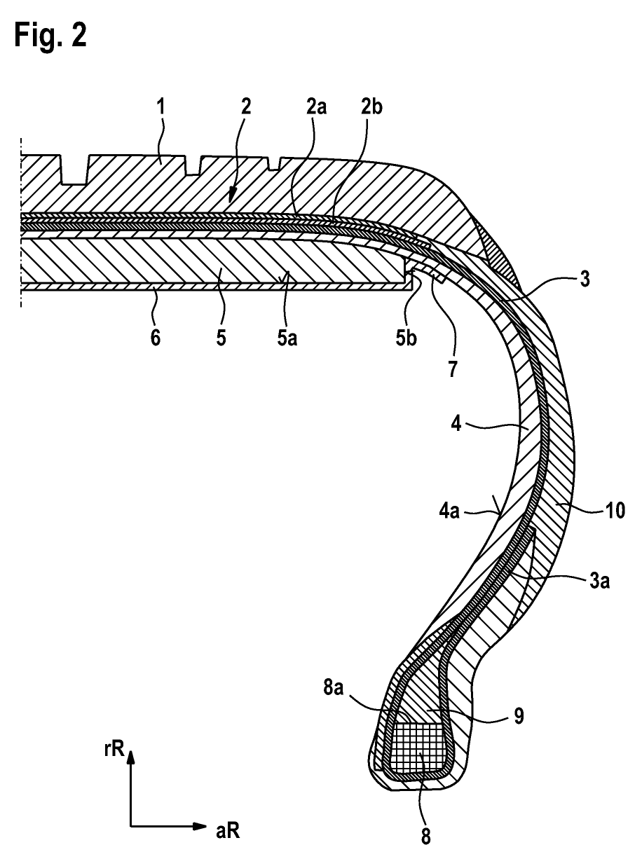

Further features, advantages and details of the invention will be discussed in detail with reference to FIGS. 1 and 2, which illustrate schematic working examples.

The essential constituents of which the self-sealing tire of the invention is composed are a profiled tread 1, a belt package 2 that consists of two plies 2a, 2b in the execution shown, a single-ply carcass 3 which is guided around the bead cores 8 and bead core profiles 9 from the inside outward in axial terms and ends in the carcass turnup 3a, and side walls 10. The two plies 2a, 2b of the belt package 2 consist of reinforcing elements of steel cord that are embedded in a rubber compound and run parallel to one another within each ply, the steel cords of the one ply 2a being oriented in a crossing arrangement in relation to the steel cords of the second ply 2b and each forming an angle between 15° and 45° with the circumferential direction of the tire. The single-ply carcass 3 may also be formed in a conventional and known way, and consequently have reinforcing fibers of a textile material or of steel cord that are embedded in a rubber compound and run in the radial direction. The self-sealing of the pneumatic vehicle tire is obtained by means of a sealant layer 5 subsequently applied circumferentially on the inside in radial direction after the vulcanization of the pneumatic vehicle tire. The sealant layer 5 has essentially the width of the belt package 2 and is arranged essentially in the projection thereof and has a cross section which is formed in the cross-sectional plane including the tire axis and has a surface 5a running essentially parallel to the belt package in axial direction and a surface 5b running essentially in radial direction. The surface 5b is present on either side in axial direction and thus constitutes the lateral boundaries of the sealant layer around the circumference.

The sealant layer 5, according to the example in FIG. 1, on the surface 5a directed radially inward, has a coating 6 containing at least elastomer particles, for example with a particle size of 0.35 to 0.55 mm.

For example, the coating additionally contains at least one alkali metal salt of at least one fatty acid and at least one alkaline earth metal salt of at least one fatty acid, where the alkaline earth metal salt of at least one fatty acid is at least calcium stearate. For example, the fatty acid is selected from the group consisting of octanoic acid and/or tetradecanoic acid and/or hexadecanoic acid and/or octadecanoic acid.

A self-sealing pneumatic vehicle tire of this kind can be obtained, for example, by first producing the pneumatic vehicle tire and then applying the sealant layer as known in the prior art and then applying an aqueous suspension comprising regenerated rubber material having an average particle size of 0.42 mm and at least one alkali metal salt of at least one fatty acid and/or at least one alkaline earth metal salt of at least one fatty acid, for example Rhenodiv® BO 7672-1 from Rheinchemie, with a spray gun and drying it. Prior to application, the regenerated rubber material is mixed here into the suspension described, for example Rhenodiv® BO 7672-1. The weight ratio of regenerated rubber material to the suspension prior to the mixing-in is, for example, 1:3.

The coating of the surface 5a in the example according to FIG. 1 may alternatively contain elastomer particles only, such as preferably regenerated rubber material from used tires. The particles are likewise applied with a spray gun having suitable nozzle diameter.

The sealant layer 5, in the example in FIG. 2, on the surface 5a running in axial direction essentially parallel to the belt package and additionally on the surface 5b running essentially in radial direction, has the coating 6 comprising at least elastomer particles. The details described for FIG. 1 are applicable, where the coating additionally comprises at least one alkali metal salt of at least one fatty acid and at least one alkaline earth metal salt of at least one fatty acid.

In addition, the coating, by virtue of the production method, overlaps the inner layer on either side in axial direction, where the overlap 7 on each side is 0.5 to 10 mm, preferably 0.5 to 2 mm, more preferably, for example, 1 mm.

A self-sealing pneumatic vehicle tire of this kind can be obtained as described in FIG. 1, where at least the surfaces 5a and 5b are coated by applying the elastomer particles in the aqueous suspension mentioned with a spray gun.

### LIST OF REFERENCE NUMERALS

### Part of the Description

1 Tread
2 Belt package
2a Belt ply
2b Belt ply
3 Carcass
3a Carcass turnup
4 Inner layer
4a Surface of the inner layer directed radially inward
5 Sealant layer
5a Surface of the sealant layer directed radially inward, running in axial direction, essentially parallel to the belt package
5b Surface of the sealant layer running in radial direction, essentially at right angles to the belt package
6 Coating
7 Overlap
8 Bead core
8a Radially outer end of the extent of the bead core
9 Bead core profile
10 Sidewall
rR Radial direction
aR Axial direction

1.-10. (canceled)

11. A self-sealing pneumatic vehicle tire comprising a belt package, a tread arranged radially above the belt package and an airtight inner layer arranged radially on the inside;
wherein the self-sealing of the pneumatic vehicle tire is obtained via a sealant layer subsequently applied radially on the inside after the vulcanization of the pneumatic vehicle tire;
wherein the sealant layer has essentially the width of the belt package and is arranged essentially in the projection thereof and has a cross section which is formed in a cross-sectional plane including the tire axis and has a surface running essentially parallel to the belt package in axial direction and a surface running essentially in radial direction; and,
wherein the at least the surface of the sealant layer running essentially parallel to the belt package in axial direction has a circumferential coating that contains at least elastomer particles.

12. The self-sealing pneumatic vehicle tire as claimed in claim 1, wherein the elastomer particles have a particle size of 0.05 to 2 mm.

13. The self-sealing pneumatic vehicle tire as claimed in claim 1, wherein the elastomer particles are based on natural polyisoprene and/or synthetic polyisoprene and/or polybutadiene and/or styrene-butadiene copolymer and/or butyl rubber and/or halobutyl rubber and/or nitrile-butadiene rubber and/or hydrogenated acrylonitrile-butadiene rubber and/or ethylene-propylene-diene rubber.

14. The self-sealing pneumatic vehicle tire as claimed in claim 1, wherein the elastomer particles comprise at least one regenerated rubber material.

15. The self-sealing pneumatic vehicle tire as claimed in claim 1, wherein the coating additionally contains at least one alkali metal salt of at least one fatty acid and/or at least one alkaline earth metal salt of at least one fatty acid.

16. The self-sealing pneumatic vehicle tire as claimed in claim 1, wherein at least the surface running in radial direction additionally has the coating.

17. A method of producing a self-sealing pneumatic vehicle tire comprising a belt package, a tread arranged radially above the belt package and an airtight inner layer arranged radially on the inside;
wherein the self-sealing of the pneumatic vehicle tire is obtained via a sealant layer subsequently applied radially on the inside after the vulcanization of the pneumatic vehicle tire;
wherein the sealant layer has roughly the width of the belt package and is arranged roughly in the projection thereof and has a cross section which is formed in a cross-sectional plane including the tire axis and has a surface running essentially parallel to the belt package in axial direction and a surface running essentially in radial direction; and,
wherein the sealant layer has been coated at least with elastomer particles.

18. The method as claimed in claim 17, wherein the elastomer particles are applied with a spray gun.

19. The method as claimed in claim 17, wherein the elastomer particles are applied in an aqueous suspension of at least one alkali metal salt of at least one fatty acid and/or of at least one alkaline earth metal salt of at least one fatty acid.

20. The method as claimed in claim 19, wherein the application is effected with a spray gun or a rotating spray turntable.
